(19) United States
(12) Patent Application Publication
(10) Pub. No.: US 2023/0306529 A1
(43) Pub. Date: Sep. 28, 2023

(54) SYSTEMS AND METHODS FOR PROVIDING A SOCIAL MEDIA STOCK EXCHANGE AND ASSOCIATED INTERACTIONS

(71) Applicant: G1 Gallegos LLC, El Paso, TX (US)

(72) Inventor: Oscar Gallegos, El Paso, TX (US)

(21) Appl. No.: 18/126,150

(22) Filed: Mar. 24, 2023

Related U.S. Application Data
(60) Provisional application No. 63/323,720, filed on Mar. 25, 2022.

(51) Int. Cl. G06Q 50/00; G06Q 40/06; G06Q 40/04

(52) U.S. Cl. CPC G06Q 50/01; G06Q 40/06; G06Q 40/04

(57) ABSTRACT

The present disclosure is for systems and a methods for providing a social media stock exchange (SMSE) platform and associated functionality. The SMSE platform provides a tool for social media content creators to list shares of stock associated with their social media platform profiles and provides other users with an opportunity to invest in individuals based on their social media profiles/content. The SMSE platform provides an approach to aggregating and standardizing data from a plurality of social media platforms and present the information to users in a way that allows for easy and efficient comparison of data across platforms in order to aid users in making trading decisions on the SMSE platform.

### CROSS-REFERENCE TO RELATED APPLICATIONS

This application claims the benefit of U.S. Provisional Application 63/323,720, filed Mar. 25, 2022, titled “SYSTEMS AND METHODS FOR PROVIDING A SOCIAL MEDIA STOCK EXCHANGE AND ASSOCIATED INTERACTIONS,” which is herein incorporated by reference in its entirety.

### BACKGROUND

There is a need for a system that allows content creators to monetize their content prior to achieving significant popularity criteria which can in turn provide the necessary revenue for their continued content creation and popularity growth. Social media platforms, in general, provide an avenue for sharing content related to interests, information of importance, endeavors, entertainment, networking, etc. While some social media platforms provide a means for monetizing the shared content, this is often only after substantial popularity criteria have been met such as having a certain number of followers, subscribers, views, and/or cumulative viewing time. Many social media presences or content creators are faced with challenges associated with financing their initial content creation and establishing themselves as a monetary worthy social media presence (that is until they meet the substantial popularity criteria as discussed above). Many may fail to achieve the necessary popularity to continue along their endeavors of creating and sharing content on social media platforms in the absence of a means to monetize or attract investment in the early stages of creating their social media account(s), content, or presence.

However, where there is opportunity for financial gain, there is also opportunity for unethical actions and attempts to take advantage of systems for personal gain. For example, social media platforms, digital content and online presences can face challenges with fraud, false or misleading information, and in some cases impersonating others for financial gain. When incorporating monetization with social media accounts, it is important to have a means of authentication so that the true content creator(s) is/are associated with social media accounts or presences in order to avoid or minimize the likelihood of the unethical actions related to social media accounts.

In order to provide content creators with an opportunity to monetize their social media presence, the present invention provides a social media stock exchange platform providing social media content creators the ability to list shares associated with their social media accounts for sale. In turn, the public is provided the opportunity to use the social media stock exchange platform to invest in social media content creators and make trades (e.g. buy and/or sell shares) through the platform. However, in order for buyers to be able to ingest this information and make trading decisions they may need to visit multiple different social media platforms for multiple content creators in order to stay up to date with changes in the corresponding social media profiles. Moreover, the information across different platforms is non-uniform and non-standardized such that comparison of information (or changes in information) between different platforms can be difficult to evaluate. For example, a content creator may have a social media presence on a plurality of separate and distinct social media platforms and may update varying content on the one platform without changing content on another platform. Information associated with these accounts are often stored in a non-standard format dictated by each distinct social media platform being used by a content creator. Moreover, different platforms have different numbers of total users so a change in popularity on one platform is not necessarily equivalent to the same change on another platform due to differing amounts of total users on the two platforms. For example, consider a hypothetical scenario where platform A has 1 million total users and platform B has 100,000 total users. A social media content creator who gains 10,000 followers on platform B gains a substantially larger percentage change in popularity on that platform (10% gain of the total platform users) as compared to a social media content creator who gains 10,000 followers on platform A (which would only be 1% gain of the total platform users). Thus, considering only the raw profile data (and changes therewith) can be misleading in the absence of some form of data standardization. It can be difficult for an interested party (e.g. an investor) to stay up to date with the various changes across different platforms and to determine what a change on one platform means with respect to a similar change on a different platform. Since this information can significantly impact investment strategies, it is important for users to be able to readily digest information about different content creators and different platforms. Moreover, users must continually monitor content creator profiles for changes and updated information as changes could impact investment strategy and missed changes could result in a loss of assets or a missed opportunity for financial gain.

### SUMMARY

The present invention overcomes these limitations by providing a social media stock exchange (SMSE) system that provides content creators with the ability to create stock offerings associated with at least one of their social media accounts and obtain revenue in response to the sale of shares associated with their stock offerings. Users are also provided with the ability to invest in content creators or social media presences of their choosing with an opportunity for financial gain should the content creator or social media presence gain popularity or should stock offerings associated therewith rise in demand and/or market value. The present invention provides the ability to verify users and authenticate their association with social media accounts in order to provide a degree of certainty that stocks being offered for sale are done so in accordance with the true and rightful owner of the social media account. This provides investors with a degree of confidence that they are investing in an authentic social media presence or content creator. Furthermore, the system provides a means for authenticating and recording transactions in such a way as to provide secure transactions and a traceable transaction history.

To solve the problems identified above, applicant has invented a social media stock exchange platform that collects, converts and consolidates social media profile information into a standardized format. The information is stored and available to be presented to users to aid in trading decisions. Furthermore, the platform updates the stored information over time and generates indicators notifying users of updated information. Because each social media platform may have different user bases and total users, and use different user profile information (e.g. likes, followers, subscribers, comments, shares, re-posts, etc.) which serve as indicators of popularity and activity, the present invention converts this information into a standardized format to make the information easier to understand and easier to compare between social media platforms and social media content creators. The SMSE platform provides a graphical user interface (GUI) for presenting the information and/or obtaining trading instructions associated with the information. A user is provided with remote access through the GUI to view the information, view notifications associated with the information, and submit trading instructions. In this way all users can quickly be notified of any changes without having to manually look up or consolidate all of the social media profile updates for a vast number of content creators. Moreover, a user does not need to attempt to determine what a change on one social media platform means with respect to a change on another social media platform as the data standardization process accounts for differences between platforms and removes ambiguity and uncertainty associated with trying to compare different platforms. This ensures that each user is given prompt notice and access to changes in social media profile data in an easy to understand and easy to compare format so they can readily adapt their own investment strategy in accordance with content creator actions or changes in content creator profile information. The notifications can be in the form of an email message, text message, smartphone notification (e.g. via a smartphone application) or other type of notification known in the art.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates a system for facilitating operations of and interactions with a social media stock exchange (SMSE) system in accordance with an exemplary embodiment of the invention.

FIG. 2 illustrates a social media stock exchange (SMSE) system in accordance with an exemplary embodiment of the present invention.

FIG. 3A illustrates an exemplary process for registering content creators with an SMSE system and initiating an SMSE stock offering according to one embodiment of the invention.

FIG. 3B illustrates an exemplary process for buying and selling stocks through an SMSE system according to one embodiment of the invention.

FIG. 3C illustrates an exemplary process for providing users with real-time information about social media profile status in association with a social media stock exchange platform according to one embodiment of the invention.

FIGS. 3D-3F illustrate exemplary graphical user interfaces (GUIs) according to various embodiments of the invention.

FIG. 4 illustrates one embodiment of the computing architecture that supports an embodiment of the inventive disclosure.

FIG. 5 illustrates components of a system architecture that supports an embodiment of the inventive disclosure.

FIG. 6 illustrates components of a computing device that supports an embodiment of the inventive disclosure.

FIG. 7 illustrates components of a computing device that supports an embodiment of the inventive disclosure.

### DETAILED DESCRIPTION

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

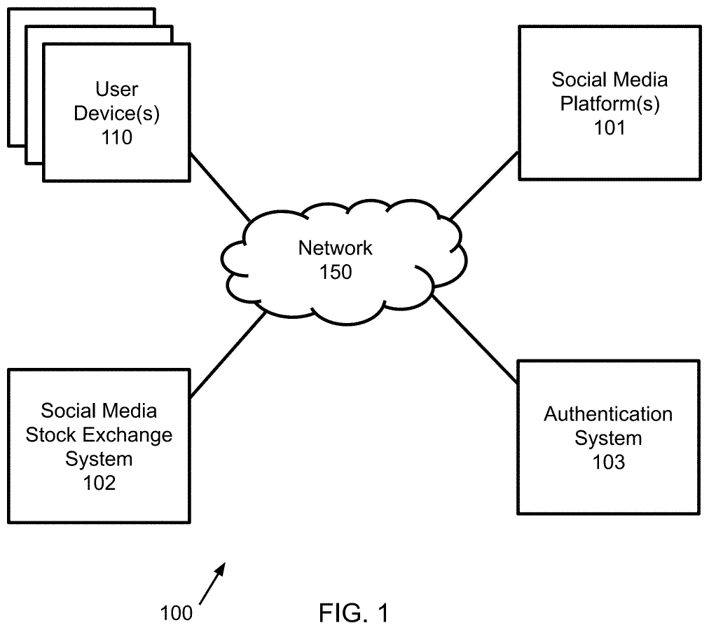

FIG. 1 illustrates an exemplary embodiment of a system 100 for facilitating operations of and interactions with a social media stock exchange (SMSE) system according to one embodiment. The system comprises user device(s) 110, social media platform(s) 101, social media stock exchange system 102, authentication system 103, and a network 150 over which the various systems communicate and interact. The various computing devices described herein are exemplary and for illustration purposes only. The system may be reorganized or consolidated, as understood by a person of ordinary skill in the art, to perform the same tasks on one or more other servers or computing devices without departing from the scope of the invention.

Social media platform(s) 101 comprise at least one social media platform through which users at least one of communicate with other users, provide content to be shared with others, and view content provided by other users. Social media platform(s) may comprise any platform and may be associated with any content, including, but not limited to, personal information, company information, documents, videos, photos, interests, endeavors, product information, services information, news information, review information, and the like.

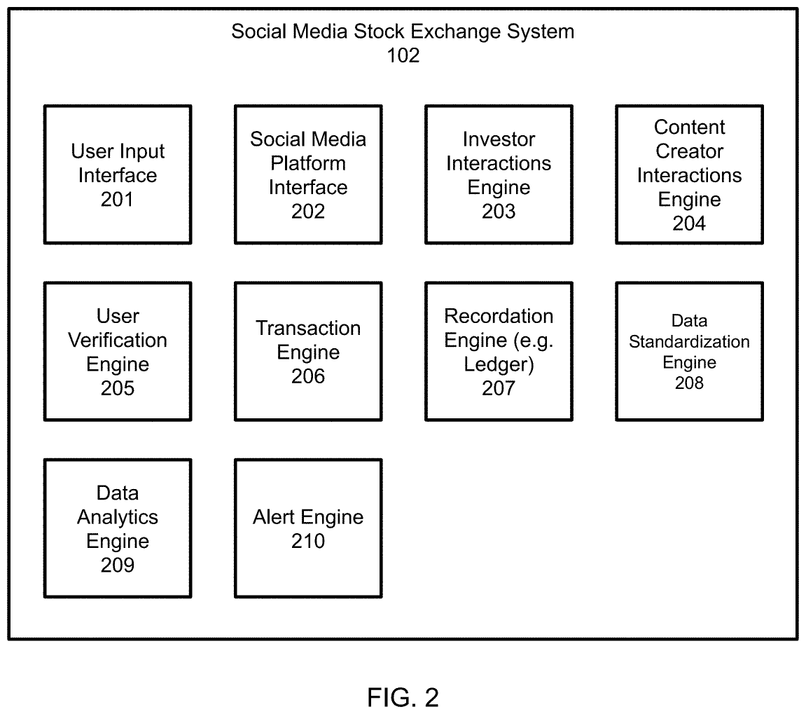

Social media stock exchange (SMSE) system 102 provides a medium for users to at least one of monetize their social media content associated with at least one social media platform and invest in at least one social media presence and/or social media content creator associated with at least one social media platform. Social media stock exchange system 102 may obtain information from users in order to register the users with the social media stock exchange system 102. Social media stock exchange system 102 may allow users to register as at least one of an investor and a creator. Creators may comprise at least one of an individual, group of individuals, company and the like associated with a social media presence with an interest in offering shares (e.g. stocks) for purchase by others. Investors may comprise individuals interested in the possibility of purchasing shares (e.g. stock) in content creators and their associated social media presence(s). Social media stock exchange system 102 may provide users with the ability to buy shares from creators and/or from other users (e.g. investors). Social media stock exchange system 102 may provide users with the ability to sell shares they own such as those previously purchased and/or shares generated in association with their social media presence, such as through an initial public offering. In this way, users are able to at least one of monetize their social media content/presence and invest in at least one social media presence and associated content. More details of the social media stock exchange system 102 can be found in the discussion of FIG. 2.

Authentication system 103 may comprise at least one system for authenticating at least one of user registrations and social media stock exchange transactions. Authentication system 103 may interface with social media platforms 101 in order to at least one of verify identities of users and associate a social media account(s) with a user. Authentication system 103 may comprise a decentralized system (e.g. blockchain) for use in performing authentication operations. Authentication system 103 may comprise an automated clearing house for verifying and/or approving transactions. Authentication system 103 may comprise a distributed ledger for use in performing authentication operations.

User device(s) 110 generally comprise a computing device which can be used by at least one of a content creator, social media presence and an investor in order to interact with at least one of the social media stock exchange system 102 and social media platform(s) 101. User device(s) 110 may be used to interact with other system components in order to at least one of register as an investor and/or creator on social media stock exchange system 102, modify content on social media platforms 101, link social media accounts to social media stock exchange accounts, and initiate and/or execute transactions (such as buying and selling stock) through social media stock exchange 102.

User device(s) 110 include, generally, a computer or computing device including functionality for communicating (e.g., remotely) over a network 150. Data may be collected from user devices 110, and data requests may be initiated from each user device 110. User device(s) 110 may be a server, a desktop computer, a laptop computer, personal digital assistant (PDA), an in- or out-of-car navigation system, a smart phone or other cellular or mobile phone, or mobile gaming device, among other suitable computing devices. User devices 110 may execute one or more applications, such as a web browser (e.g., Microsoft Windows Internet Explorer, Mozilla Firefox, Apple Safari, Google Chrome, and Opera, etc.), or a dedicated application to submit user data, or to make prediction queries over a network 150.

In particular embodiments, each user device 110 may be an electronic device including hardware, software, or embedded logic components or a combination of two or more such components and capable of carrying out the appropriate functions implemented or supported by the user device 110. For example and without limitation, a user device 110 may be a desktop computer system, a notebook computer system, a netbook computer system, a handheld electronic device, or a mobile telephone. The present disclosure contemplates any user device 110. A user device 110 may enable a network user at the user device 110 to access network 150. A user device 110 may enable its user to communicate with other users at other user devices 110.

A user device 110 may have a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user device 110 may enable a user to enter a Uniform Resource Locator (URL) or other address directing the web browser to a server, and the web browser may generate a Hyper Text Transfer Protocol (HTTP) request and communicate the HTTP request to server. The server may accept the HTTP request and communicate to the user device 110 one or more Hyper Text Markup Language (HTML) files responsive to the HTTP request. The user device 110 may render a web page based on the HTML files from server for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

The user device 110 may also include an application that is loaded onto the user device 110. The application obtains data from the network 150 and displays it to the user within the application interface.

Exemplary user devices are illustrated in some of the subsequent figures provided herein. This disclosure contemplates any suitable number of user devices, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing system may perform at different times or at different locations one or more steps of one or more methods described or illustrated herein, where appropriate.

Network cloud 150 generally represents a network or collection of networks (such as the Internet or a corporate intranet, or a combination of both) over which the various components illustrated in FIG. 1 (including other components that may be necessary to execute the system described herein, as would be readily understood to a person of ordinary skill in the art). In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. One or more links connect the systems and databases described herein to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 150, and any suitable link for connecting the various systems and databases described herein.

The network 150 connects the various systems and computing devices described or referenced herein. In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 421 or a combination of two or more such networks 150. The present disclosure contemplates any suitable network 150.

One or more links couple one or more systems, engines or devices to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 150.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to client/user devices or other devices in response to HTTP or other requests from client devices or other devices. A mail server is generally capable of providing electronic mail services to various client devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiment, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

FIG. 2 illustrates an exemplary embodiment of the social media stock exchange system 102. Social media stock exchange system 102 may comprise user input interface 201, social media platform interface 202, investor interactions engine 203, content creator interactions engine 204, user verification engine 205, transaction engine 206, and recordation engine 207. The various components described herein are exemplary and for illustration purposes only and any combination or subcombination of the various components may be used as would be apparent to one of ordinary skill in the art. Other systems, interfaces, modules, engines, databases, and the like, may be used, as would be readily understood by a person of ordinary skill in the art, without departing from the scope of the invention. Any system, interface, module, engine, database, and the like may be divided into a plurality of such elements for achieving the same function without departing from the scope of the invention. Any system, interface, module, engine, database, and the like may be combined or consolidated into fewer of such elements for achieving the same function without departing from the scope of the invention. All functions of the components discussed herein may be initiated manually or may be automatically initiated when the criteria necessary to trigger action have been met.

User input interface 201 obtains input from at least one user in association with at least one of registering with social media stock exchange system 102 and conducting stock related research, inquiries, and/or transactions. User input interface may obtain user input associated with users comprising at least one of user identification information (e.g. name, date of birth, social security number, etc.), an indication whether the user is an investor and/or creator, user bank account information, social media account information and the like. This list is merely exemplary and other user information may be obtained as would be apparent to one of ordinary skill in the art without departing from the scope of the invention.

Social media platform interface 202 obtains information from at least one social media platform in order to at least one of associate a social media account(s) with a registered user(s), verify authenticity of a social media account(s), obtain social media content or associated information, obtain data associated with at least one social media presence/creator such as number of followers, subscribers, likes, type of content, age of content, frequency at which new content is added (e.g. daily, weekly, monthly, etc.), and the like. Social media platform interface 202 may automatically obtain information upon initial user registration. Social media platform interface 202 may automatically obtain updated information at periodic intervals after user registration such as daily, weekly, monthly, etc. Social media platform interface 202 may automatically obtain updated information upon obtaining an indication that information is associated with a social media account(s) has changed, such as at least one of new content has been uploaded on a social media platform, changes in number of followers, subscribers, likes, and/or content aspects, etc.

Investor interactions engine 203 is operable to provide users with the ability to at least one of register as an investor, view available SMSE stock offerings, purchase SMSE stock offerings, research SMSE stocks, and sell SMSE stocks which the investor currently owns. Investor interactions engine 203 may provide investors with an indication of currently available SMSE stocks and their associated market price. Investor interactions engine 203 may provide an analysis of at least one of current, past, and predicted market price. For example, investor interactions engine 203 may provide investors with, for each SMSE stock, at least one of a computed market value, trends associated with the market value, trends associated with the market price, projections associated with future market value, and an indication whether current price is fairly priced with respect to market value calculations. Investor interactions engine 203 may provide recommendations to investors based on at least one of user preferences and past user transactions associated with the SMSE system 102.

Content creator interactions engine 204 is operable to provide users with the ability to at least one of register as a content creator (or social media presence), and initiate and control SMSE stock offerings associated with their social media account(s). Content creator interactions engine 204 may obtain information associated with at least one of the user and associated social media account(s). Content creator interactions engine 204 may initiate a verification process (e.g. via user verification engine 205 as discussed below) prior to allowing users to complete the registration process and/or prior to allowing users to offer SMSE stocks for purchase by other users. Content creator interactions engine 204 may obtain initial public offering (IPO) information (e.g. share price, number of shares, etc.) from users (e.g. content creators) in order to create SMSE stock offerings in accordance with the IPO information. Content creator interactions engine 204 may make recommendations to users (e.g. content creators) regarding IPO details such as share price, number of shares, etc. Content creator interactions engine 204 may obtain social media account(s) data for use in making recommendations regarding IPO details. In one aspect, the social media account(s) data may comprise at least one of number of followers, subscribers, likes, type of content, age of content, frequency at which new content is added (e.g. daily, weekly, monthly, etc.), and the like. Content creator interactions engine 204 may analyze obtained IPO information in light of obtained social media account(s) data in order to provide an indication to users (e.g. content creators) regarding the quality of their provided IPO information. For example, analysis of the social media account(s) data may be used to provide an indication whether the share price is within a threshold of a fair market value.

User verification engine 205 is operable to verify and/or authenticate user information including, but not limited to, login credentials, identity information, bank account information, social media account information, and the like. User verification engine 205 may interact with external systems in order to verify and/or authenticate at least one of the above mentioned user information. In one aspect, user verification engine 205 may perform a verification process in order to determine, with a sufficient degree of certainty, that a user registering as a content creator is who they claim to be and not impersonating a social media presence. In this way, stock offerings provided through the SMSE system can be provided with a degree of confidence that they are being offered in accordance with instruction from the rightful owner of the social media account.

Transaction engine 206 is operable to process transactions associated with at least one of buying and selling of SMSE stocks. Transaction engine 206 may at least one of obtain SMSE stock offering data, provide SMSE stock offering data, obtain SMSE stock purchase request information, obtain SMSE stock sale request information, obtain SMSE stock sale approval information, and the like. Transaction engine 206 may comprise and/or communicate with a transaction processing system, such as an automated clearing house system. Transaction engine 206 may obtain and/or provide information from/to at least one recordation system (such as recordation engine 207, authentication system 103, decentralized/blockchain system, distributed ledger, etc.) as part of authenticating and/or processing transactions.

Recordation engine 207 is operable to record transactions associated with transaction engine 206. Recordation engine 207 may comprise a ledger based approach for recording transactions. Recordation engine 207 may communicate with authentication system 103 as described above in order to record transactions. Recordation engine 207 may comprise and/or communicate with at least one of a decentralized recording system, blockchain system and distributed ledger system.

Data standardization engine 208 is operable to convert the data from different social media platforms into a standardized format. Data standardization engine 208 converts social media profile data from different platforms, which may comprise different data and/or metrics depending on the platform from which the social media profile information is obtained, into a standardized format. Data standardization engine 208 may identify social media profile data metrics which are similar between different social media platforms and convert them to a standardized metric or format which accounts for differences between the social media platforms. For example, converting may comprise accounting for the total number of users on a corresponding social media platform (e.g. evaluating a number of followers relative to total users on a given social media platform) to standardize the social media profile information relative to the overall popularity of a given social media platform. This is merely one example of how the converting can be done and what characteristics of the social media platforms are considered in the standardization and other converting approaches for standardization may be used without departing from the scope of the invention as would be apparent to one of ordinary skill in the art.

Data analytics engine 209 is operable to process at least one of social media profile data and SMSE stock data (e.g. market value, transaction data) to determine characteristics associated with the profile data and/or SMSE stock. Data analytics engine 209 may compute at least one of changes in social media profile data and/or SMSE stock data, evaluate trends associated with social media profile data and SMSE stock data, determine social media profile data satisfy certain criteria (e.g. exceed or fall below at least one threshold).

Alert engine 210 is operable to generate notifications associated with characteristics associated with at least one of SMSE stocks and social media content creator profile data associated with an SMSE platform. Alert engine 210 may generate alerts and/or notifications automatically when certain criteria have been met. Alert engine 210 may generate alerts and/or notifications in association with computations performed by the data analytics engine 209. Alert engine 210 may generate alerts and/or notifications in association with at least one of obtaining updated social media profile data, analysis of social media profile data and/or SMSE stock data indicating a change (e.g. beyond a threshold), analysis of social media profile data and/or SMSE stock data indicating a trend or a change in a trend characteristic (e.g. a switch from trending upwards to trending downwards, or vice versa). Alert engine 210 may generate alerts and/or notifications in association with the location of a content creator in relation to the location of an end user of the SMSE platform (e.g. when a content creator and end-user, such as an investor, are within a threshold distance of each other).

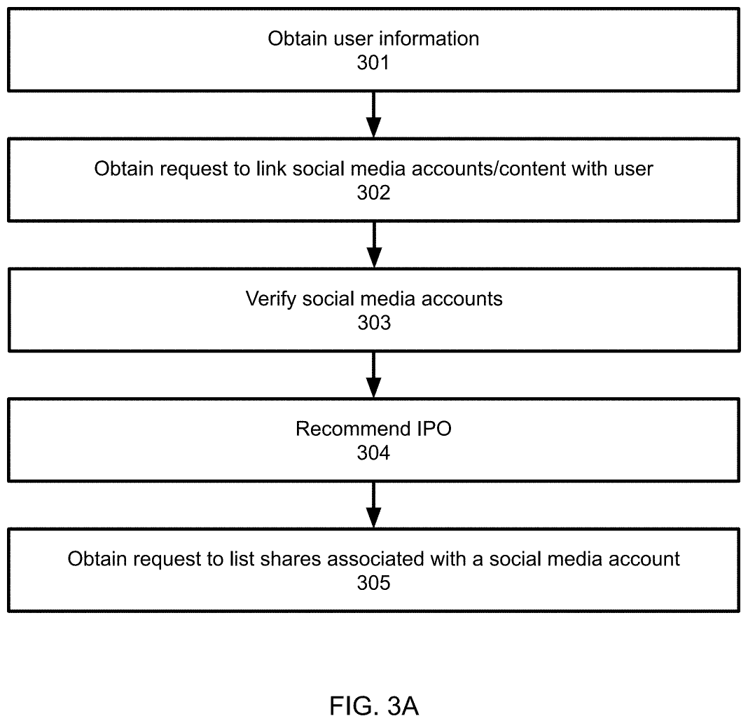

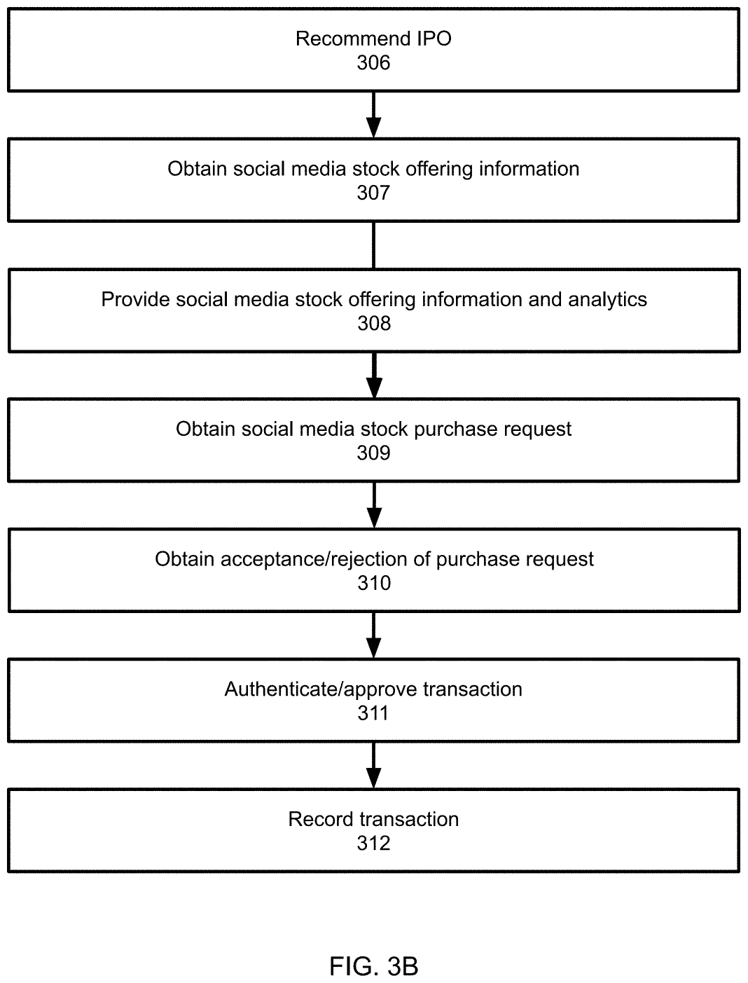

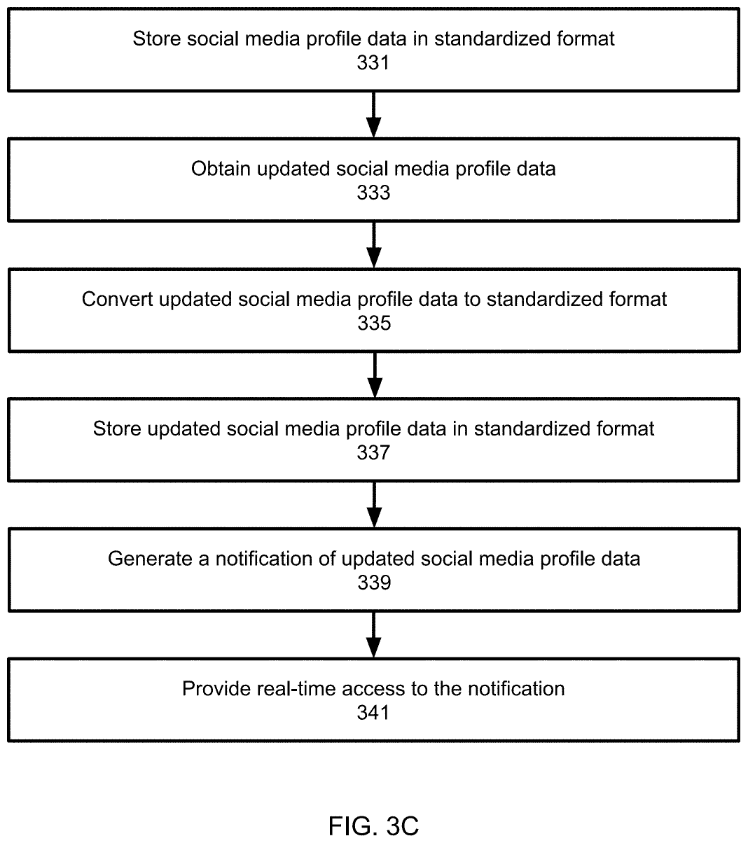

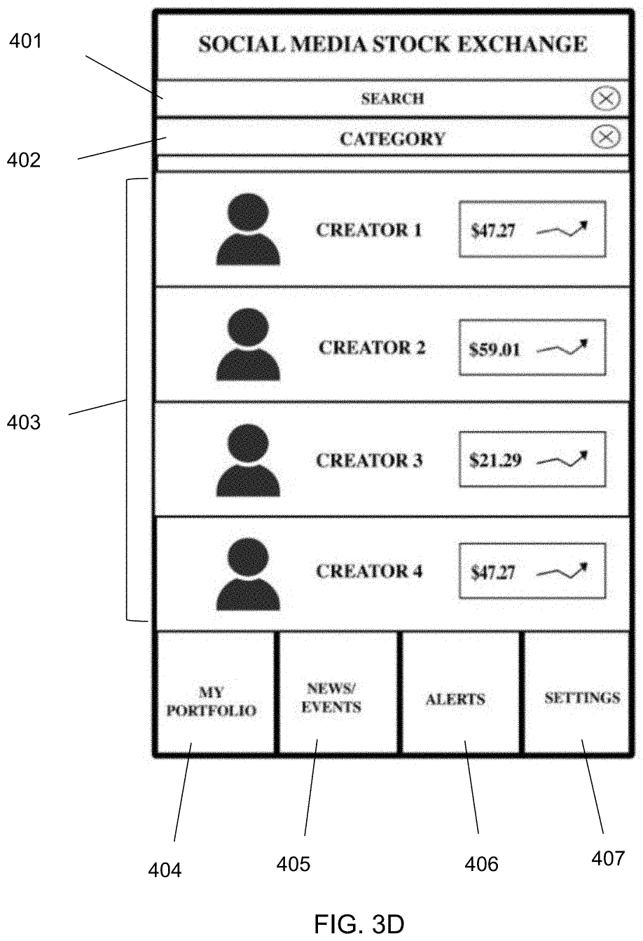

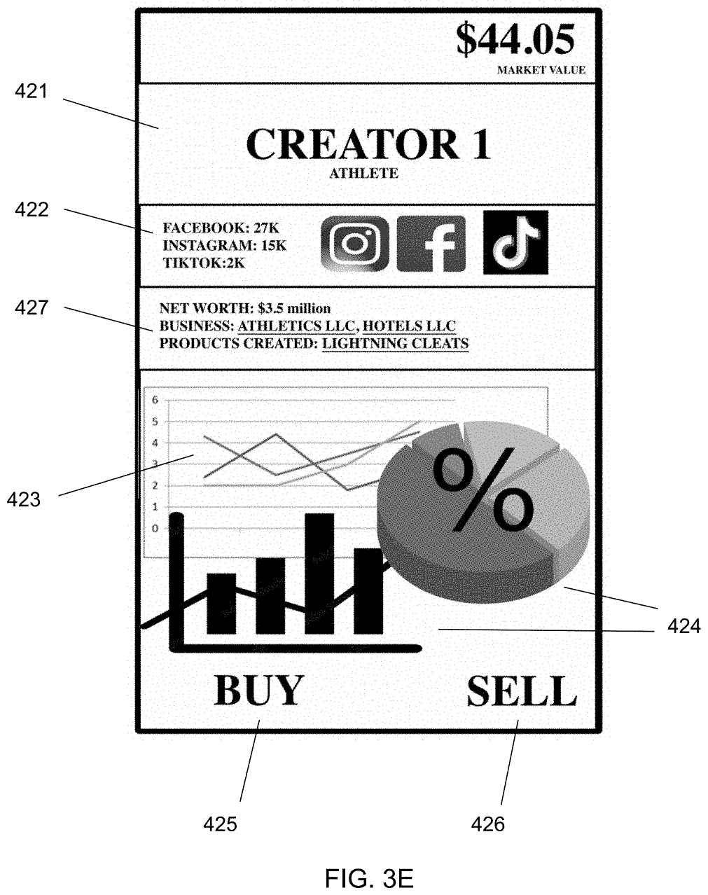

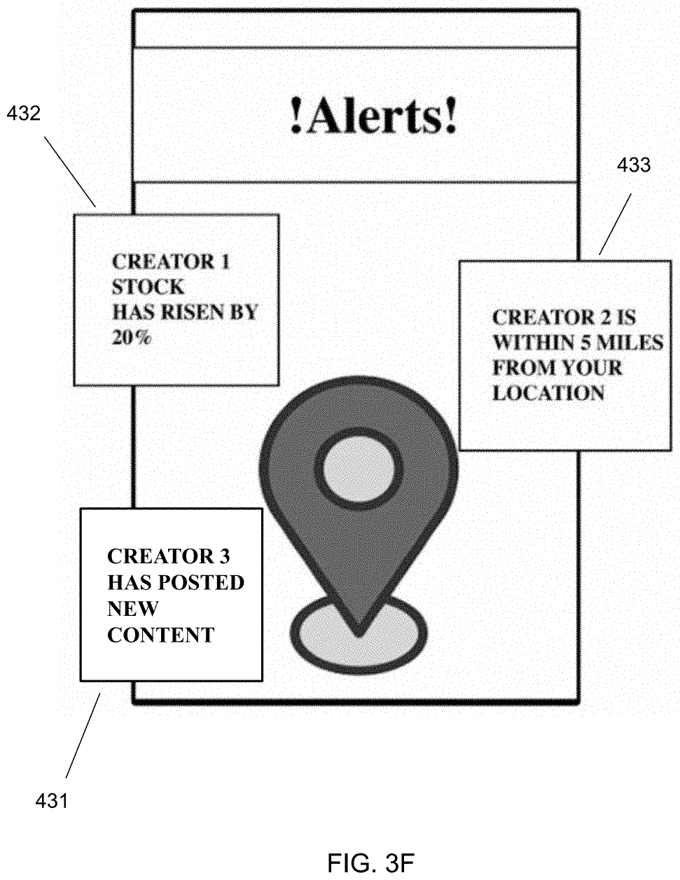

FIG. 3A illustrates an exemplary process for registering content creators with an SMSE and initiating an SMSE stock offering. The process comprises obtaining user information 301, obtaining a request to link social media accounts/content with a user 302, verifying social media accounts 303, recommending an IPO 304, and obtaining a request to list shares associated with a social media account 305. Any of the above steps may be excluded and/or additional steps added without departing from the scope of the invention as would be apparent to one of ordinary skill in the art. The order of any steps presented or any added steps may be performed in an order other than that presented without departing from the scope of the invention.

At step 301, the process may comprise obtaining user information associated with registering a user as a content creator or social media presence with a SMSE system (such as system 102 described above). User information may comprise at least one of user identification information, user bank account information, social media account information and the like.

At step 302, the process may comprise obtaining a request to link at least one social media account and/or social media content with a user. In one aspect, after a user registers as a content creator or social media presence with the SMSE, a request to link the registered user with at least one social media account associated with at least one social media platform may be obtained. Once the linking is complete (such as after verification), the social media account(s) may be associated with the user and any corresponding SMSE shares affiliated with that social media account(s).

At step 303, the process may comprise verifying social media accounts. In one aspect, verification may comprise verifying that a user registered with an SMSE system is who they are claiming to be and/or authorized to establish a link between an SMSE account and an identified social media account. Verification may be performed in a variety of ways as would be apparent to one of ordinary skill in the art. In one aspect, verification may comprise two step verification. In one aspect, verification may comprise using contact information associated with the social media account in order to communicate with the owner of the social media account to obtain verification that the owner is attempting to link their social media account with an SMSE system. In one aspect, verification may comprise prompting a user to login in to the social media account they are attempting to link as a means of confirming with a degree of certainty that they are the owner of the social media account.

At step 304, the process may comprise recommending an IPO to a registered user. In one aspect, this may comprise obtaining data associated with at least one social media account, such as at least one of number of followers, subscribers, likes, type of content, age of content, frequency at which new content is added (e.g. daily, weekly, monthly, etc.), and the like and analyzing the data in order to determine recommended IPO details such as number of shares to offer and a starting share price. In one aspect, trends associated with the above data may be analyzed in order to generate the recommendations. In some embodiments, step 304 may be omitted such as when a user prefers to establish their own IPO details without a recommendation.

At step 305, the process may comprise obtaining a request to list shares associated with a social media account through an SMSE system. The request may comprise IPO details such as a user selecting recommended IPO details or a user establishing different IPO details. Once IPO details have been obtained and the request to list shares in accordance with the IPO details are obtained, the shares may then be listed through an SMSE system.

FIG. 3B illustrates an exemplary process for buying and selling stocks through an SMSE system. The process comprises recommending an IPO 306, obtaining social media stock offering information 307, providing social media stock offering information and analytics 308, obtaining a social media stock purchase request 309, obtaining acceptance/rejection of a purchase request 310, authenticating and approving a transaction 311, and recording the transaction 312. The process may comprise additional steps, fewer steps, and/or a different order of steps without departing from the scope of the invention as would be apparent to one of ordinary skill in the art.

At step 306, the process may comprise recommending an IPO to a registered user. In one aspect, this may comprise obtaining data associated with at least one social media account, such as at least one of number of followers, subscribers, likes, type of content, age of content, frequency at which new content is added (e.g. daily, weekly, monthly, etc.), and the like and analyzing the data in order to determine recommended IPO details such as number of shares to offer and a starting share price. In one aspect, trends associated with the above data may be analyzed in order to generate the recommendations. In some embodiments, step 306 may be omitted such as when a user prefers to establish their own IPO details without a recommendation.

At step 307, the process may comprise obtaining social media stock offering information such as IPO details. The stock offering information may be obtained in accordance with generated recommendations (e.g. from step 306) and/or may be obtained based on information provided by a user. The stock offering information may comprise at least one of the number of shares being offered and the corresponding price per share.

At step 308, the process may comprise providing the social media stock offering information so that interested parties are provided with an opportunity to purchase shares. In one aspect, the stock offering information may be provided through an SMSE system (such as the one described above in FIGS. 1-2). In one aspect, the stock offering information may be provided to users registered with an SMSE system along with analytics associated with the stock offering information. In one aspect, the analytics may be based on at least one of the corresponding social media account data such as at least one of number of followers, subscribers, likes, type of content, age of content, frequency at which new content is added (e.g. daily, weekly, monthly, etc.), and the like. In one aspect, the analytics may comprise computing an estimated market value associated an SMSE stock, wherein the estimated market value is determined based on a valuation algorithm, the valuation algorithm based on at least one of current SMSE stock market value, supply/demand information (e.g. trading information such as trading volume) and social media profile data/statistics. The analytics may provide investors with an indication of whether the offering appears to be at fair market value as determined from analyzing the social media account data.

At step 309, the process may comprise obtaining an SMSE stock purchase request. In one aspect, the stock purchase request may be for at least one of shares being offered by a content creator, such as through an IPO, shares being offered by an investor/owner of shares who previously acquired the shares, and a bid for shares of a stock such as in the absence of a clear offering of a stock. In one aspect, the purchase request may be associated with a timeframe establishing how long the request is valid for or will remain open.

At step 310, the process may comprise at least one of acceptance or rejection of a stock purchase request. In one aspect, any owner of a stock associated with the stock indicated in an SMSE purchase request may accept the purchase offer. In one aspect, in the absence of an acceptance, the purchase request is considered rejected. In one aspect, the purchase request may be automatically rejected if there is no acceptance within a time frame associated with a purchase request.

At step 311, the process may comprise authenticating and approving a transaction to transfer ownership of a stock to another party in exchange for the accepted and agreed upon purchase price. In one aspect, authentication and approval may be processed through an automated clearing house. In one aspect, authentication and approval may be done in accordance with an authentication system and corresponding features such as those described above with respect to authentication system 103 and/or transaction engine 206.

At step 312, the process may comprise recording the transaction in a secure manner. In one aspect, recording may comprise use of a ledger based approach for recording transactions. In one aspect, recording may comprise use of and/or communicate with at least one of a decentralized recording system, blockchain system and distributed ledger system.

FIG. 3C illustrates an exemplary process for obtaining, standardizing and presenting profile data for use in aiding trading decisions on a social media stock exchange platform according to an exemplary embodiment of the invention. The process comprises storing social media profile data in a standardized format 331, obtaining updated social media profile data 333, converting the updated social media profile data into a standardized format 335, storing the updated social media profile data in the standardized format 337, generating a notification of updated social media profile data 339, providing real-time access to the notification 341. The process may comprise additional steps, fewer steps, and/or a different order of steps without departing from the scope of the invention as would be apparent to one of ordinary skill in the art.

At step 331, the process may comprise storing social media profile data in a standardized format. Storing may comprise storing previously obtained social media profile data which has been converted into the standardized format. Social media profile data may comprise data from a plurality of social media platforms. Social media profile data may comprise at least one of a number of followers, number of subscribers, number of likes, number of views, number of comments, number of posts, number of re-posts, and a number of shares converted into a standardized format.

At step 333, the process may comprise obtaining updated social media profile data. Obtaining updated social media profile data may comprise obtaining profile data in a non-standardized, non-universal format due to differences in the social media platforms from which the data is obtained. Obtaining updated social media profile data may comprise updated data associated with at least one of a number of followers, number of subscribers, number of likes, number of views, number of comments, number of posts, number of re-posts, and a number of shares. Obtaining updated social media profile data may comprise use of at least one API (application programing interface) to pull profile data from at least one social media platform. Obtaining updated social media profile data may comprise periodically obtaining updated profile data such as daily, weekly, hourly, every several hours, multiple times per hour, every several minutes, etc. These are merely examples of the time intervals at which updated data may be obtained and other time intervals may be used without departing from the scope of the invention as would be apparent to one of ordinary skill in the art.

At step 335, the process may comprise converting the updated social media profile data into a standardized format. Since various social media platforms use different profile metrics and there is no universal metric(s) associated with content creator popularity across all social media platforms, it is difficult to compare popularity and/or popularity changes across platforms. Moreover, different platforms have different numbers of total users so a change in popularity on one platform is not necessarily equivalent to the same change on another platform due to differing amounts of total users on the two platforms. For example, consider a hypothetical scenario where platform A has 1 million total users and platform B has 100,000 total users. A social media content creator who gains 10,000 followers on platform B gains a substantially larger percentage change in popularity on that platform (10% gain of the total platform users) as compared to a social media content creator who gains 10,000 followers on platform A (which would only be 1% gain of the total platform users). Thus, considering only the raw profile data (and changes therewith) can be misleading in the absence of some form of data standardization. A standardized format serves to assimilate the different profile data and corresponding metrics to standardized format allowing for easier and more efficient comparison between and across social media platforms. Converting may comprise identifying profile data metrics which are similar between different social media platforms and converts them to a standardized metric or format which accounts for differences between the social media platforms. For example, converting may comprise accounting for the total number of users on the corresponding social media platform (e.g. evaluating a number of followers relative to total users on a given social media platform). This is merely one example of how the converting can be done and what characteristics of the social media platforms are considered in the standardization and other converting approaches for standardization may be used without departing from the scope of the invention as would be apparent to one of ordinary skill in the art.

At step 337, the process may comprise storing the updated social media profile data in the standardized format. Storing the updated social media profile data may comprise adding a new database entry for the updated data and associating the new database entry and corresponding data with a social media content creator and/or social media stock exchange stock (e.g. through use of an identifier). In this way, historic profile data may be accessed for analyzing characteristics over time, such as determining trends. Storing the updated social media profile data may comprise replacing an existing database entry associated with the social media content creator and/or SMSE stock.

At step 339, the process may comprise generating a notification associated with the updated social media profile data. Generating a notification may comprise a notification that updated social media profile data has been obtained. Generating a notification may comprise a notification that social media profile data has changed (e.g. in excess of a threshold amount). Generating a notification may comprise a notification that social media profile data has met (or fallen below) certain thresholds (e.g. a threshold number of followers, and/or other profile data as described above, etc.). Generating a notification may comprise a notification a stock value of an SMSE stock associated with the updated social media profile data has changed (e.g. in excess of a threshold amount). Generating a notification may comprise a notification that at least one of social media profile data and SMSE stock value associated with the profile data has met certain trend criteria (e.g. is trending in a certain direction for a threshold period of time, trend direction has changed, trend rate has changed, etc.). Generating a notification may comprise a notification to be provided when the user accesses their account so that they are alerted that there is up to date information to be viewed (e.g. see FIG. 3F below). The notification may be generated automatically as the updated social media profile data is processed and the above characteristics or criteria are determined, such as via a processor.

At step 341, the process may comprise providing real-time access to at least one of the notification, updated social media profile data, and corresponding analysis of said data and/or SMSE stock value data. Providing real-time access may comprise providing real-time access to at least one SMSE platform user. Providing real-time access may comprise transmitting at least one notification to at least one user such as via at least one of an email, a text (SMS) message, a prompt on a user interface of the SMSE platform, a prompt on a user device associated with an SMSE user. Providing real-time access may comprise providing real-time access to at least one user who owns at least one share of an SMSE stock associated with the updated social media profile data. Providing real-time access may comprise providing real-time access to a plurality of users who own at least one share of an SMSE stock associated with the updated social media profile data. Providing real-time access may comprise providing access through a graphical user interface (GUI), such as those associated with FIGS. 3D, 3E and 3F described below.

The process may further comprise steps associated with executing a transaction in association with the above standardized information. For example, the process may comprise additional steps such as 309, 310, 311, and/or 312 as presented and discussed in association with FIG. 3B above.

FIG. 3D illustrates an exemplary GUI for viewing SMSE information and/or navigating to different SMSE information. The GUI may comprise UI element 401 which may comprise an interactive element allowing a user to search through the SMSE platform for information such as content creators (including associated SMSE stocks). The GUI may comprise UI element 402 which may comprise an interactive element allowing a user to search through the SMSE platform for information via a category based search such as to identify content creators and/or associated SMSE stocks based on the category (e.g. athletes, influencers, entertainers, inventors, product/brand creators, instructors/trainers, entrepreneurs, etc.). The GUI may comprise UI element 403 which displays content creators and their associated stock on the SMSE. UI element 403 may display a random selection of content creators and associated stocks. UI element 403 may display content creators and associated stocks which are experiencing the greatest changes or strongest trends over a recent time period. UI element 403 may display content creators and associated SMSE stocks which the user owns and/or has flagged as a content creator/stock to watch (e.g. be provided with updates on a recurring basis) on the SMSE. UI element 403 may comprise at least one interactive element allowing a user to navigate to obtain additional information associated with a selected content creator and/or their associated SMSE stock (e.g. updated social media profile data, trend analysis, etc.). The GUI may comprise UI element 404 which may comprise an interactive element allowing users to navigate to a display of information associated with their current assets and/or investments on the SMSE platform. The GUI may comprise UI element 405 which may comprise an interactive element allowing users to navigate to a display of information associated with news and/or events which may have an impact on values of SMSE stocks or may affect social media profile data associated with content creators. The GUI may comprise UI element 406 which may comprise an interactive element allowing users to navigate to a display of notifications and/or alerts associated with SMSE stocks and/or social media profile data. The GUI may comprise UI element 407 which may comprise an interactive element allowing users to navigate to a display of information associated with user settings associated with the SMSE platform.

FIG. 3E illustrates an exemplary GUI for displaying detailed information associated with a particular content creator. The GUI may comprise UI element 421 which may display at content creator identifiers and/or descriptors, such as content creator name, type (e.g. athlete, influencer, entertainer, etc.), etc., The GUI may comprise UI element 422 which may display at least one social media platform associated with the content creator information displayed in 421. UI element 422 may display a corresponding number of followers or other social media profile data for each social media platform displayed. The GUI may comprise UI element 427 which may display business or venture related information associated with the creator information displayed in 421. For example, UI element 427 may display at least one of a net worth associated with the content creator and/or each business they own or are affiliated with. UI element 427 may display at least one business name associated with the content creator which may include an interactive element allowing a user to navigate to additional information associated with the business. UI element 427 may display at least one product associated with the content creator which may include an interactive element allowing a user to navigate to additional information associated with the product. The GUI may comprise UI element 423 which may display at least one of SMSE stock value and standardized social media profile information associated with at least one social media platform, wherein the social media profile information may include at least one of a display of historical data and trend analysis information. The GUI may comprise UI element 424 which may display alternate formats of SMSE stock value information and/or social media profile data (e.g. in standardized and/or non-standardized formats). The GUI may comprise UI element 425 which may display an interactive element allowing user to initiate a purchase of an SMSE stock associated with the creator information displayed in 427. The GUI may comprise UI element 426 which may display an interactive element allowing user to initiate a sale of an SMSE stock associated with the creator information displayed in 427. Any of the UI elements of FIG. 3E may comprise at least one interactive element allowing a user to navigate to another UI display of more detailed information associated with the UI element(s) of FIG. 3E.

FIG. 3F illustrates an exemplary GUI for displaying at least one of alerts and notifications associated with at least one of SMSE stocks and social media profile data for content creators associated with the SMSE. The GUI may comprise UI element 431 which may display a notification or alert associated with at least one of social media profile data and social media content associated with a content creator (e.g. a change in content creator popularity metrics or profile data). The GUI may comprise UI element 432 which may display a notification or alert associated with a change in SMSE stock value associated with a content creator. The GUI may comprise UI element 433 which may display a notification or alert associated with the location of a social media content creator relative to the location of a user interacting with the GUI. Any of the UI elements of FIG. 3E may comprise at least one interactive element allowing a user to navigate to another UI display of more detailed information associated with the UI element(s) of FIG. 3E.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

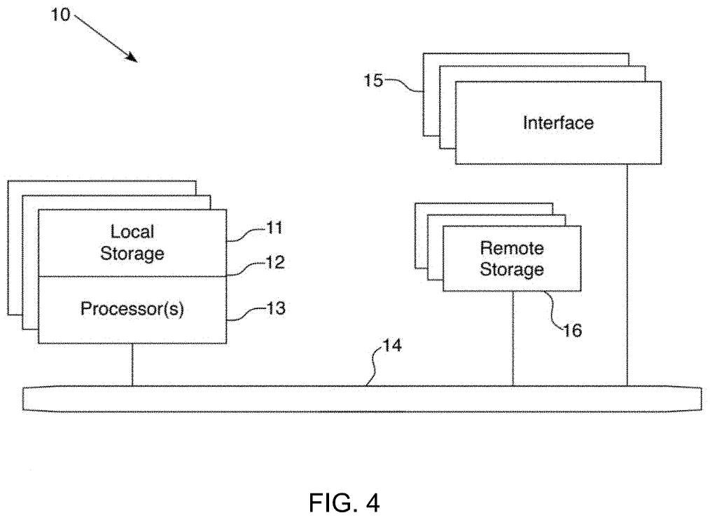

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments). Any of the above mentioned systems, units, modules, engines, controllers, components, interfaces or the like may be and/or comprise hardware and/or software as described herein. For example, the social media stock exchange system 102 and subcomponents thereof may be and/or comprise computing hardware and/or software as described herein in association with FIGS. 4-7. Furthermore, any of the above mentioned systems, units, modules, engines, controllers, components, interfaces or the like may use an application programming interface (API) in communicating with other systems units, modules, engines, controllers, components, interfaces or the like for obtaining and/or providing data or information.

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 4 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

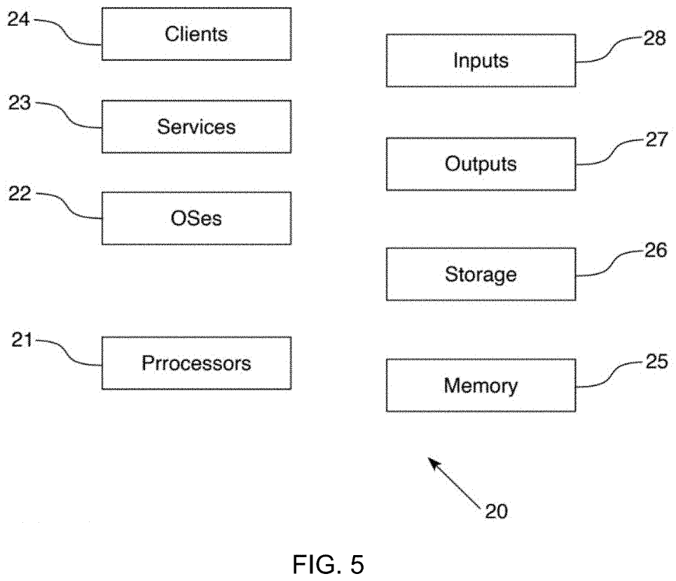

In some embodiments, systems may be implemented on a standalone computing system. Referring now to FIG. 5, there is shown a block diagram depicting a typical exemplary architecture of one or more embodiments or components thereof on a standalone computing system. Computing device 20 includes processors 21 that may run software that carry out one or more functions or applications of embodiments, such as for example a client application. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 4). Examples of storage devices 26 include flash memory, magnetic hard drive, CD-ROM, and/or the like.

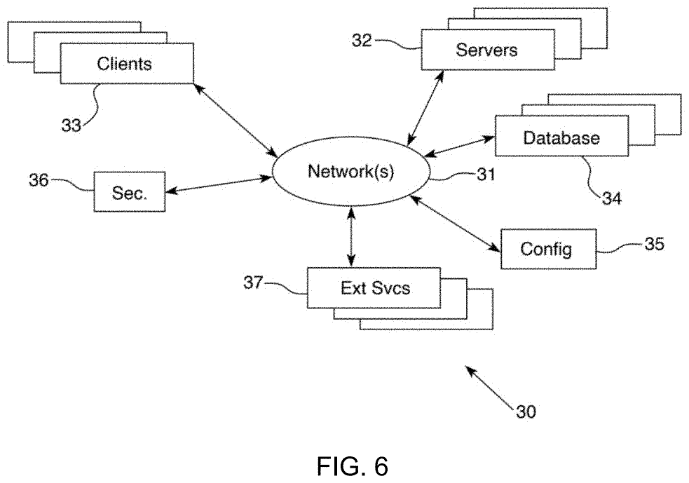

In some embodiments, systems may be implemented on a distributed computing network, such as one having any number of clients and/or servers. Referring now to FIG. 6, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 5. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications are implemented on a smartphone or other electronic device, client applications may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

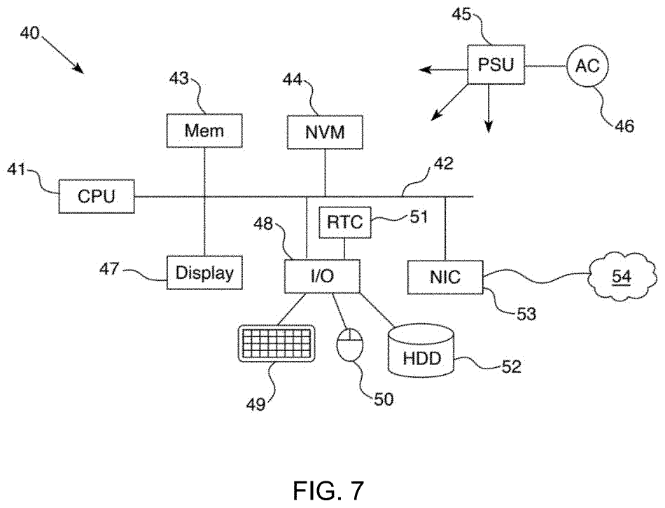

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A computer implemented method for providing users with real-time information about social media profile status in association with a social media stock exchange platform, the computer implemented method comprising:
storing social media profile data from a plurality of social media platform in at least one network-based storage device, the social media profile data being stored in a standardized format, the social media profile data associated with a plurality of social media content creators;
obtaining updated social media profile data from a plurality of social media platforms, the updated social media profile data comprising a non-standardized format based on the social media platform from which the social media profile data was obtained;
converting the non-standardized format of the updated social media profile data into the standardized format;
storing the updated social media profile data in the standardized format;
automatically generating a notification associated with the updated social media profile data; and
providing a plurality of users of the social media stock exchange platform with real-time access to the notification over a computer network so that each user has immediate access to the up to date information in the standardized format for use in making trading decisions via the social media stock exchange platform.

2. The computer implemented method according to claim 1, wherein the social media profile data comprises at least one of a number of followers, number of subscribers, number of likes, number of views, number of comments, number of posts, number of re-posts, and number of shares.

3. The computer implemented method according to claim 1, wherein the social media profile data is analyzed to compute at least one change in the social media profile data and/or at least one trend associated with the social media profile data.

4. The computer implemented method according to claim 3, wherein at least one of the at least one change and the at least one trend are used in a valuation algorithm for determining a market value of a stock associated with the social media profile data.

5. The computer implemented method according to claim 1, further comprising storing a social media stock exchange market value of a stock associated with the social media profile data, wherein storing the social media stock exchange market value comprises storing updated market values at periodic intervals.

6. The computer implemented method according to claim 5, wherein the market value is analyzed to compute at least one change in the market value and/or at least one trend associated with the market value.

7. The computer implemented method according to claim 5, wherein the social media profile data is analyzed in combination with the market value to compute at least one change and/or at least one trend associated with the combination of social media profile data and market value.

8. The computer implemented method according to claim 1, wherein obtaining updated social media profile data comprises obtaining updated social media profile data at periodic time intervals.

9. The computer implemented method according to claim 1, wherein obtaining updated social media profile data comprises at least one application programming interface (API) request associated with at least one social media platform.

10. The computer implemented method according to claim 1, wherein generating a notification comprises generating a notification when a change in SMSE stock value data exceeds a threshold.

11. The computer implemented method according to claim 1, wherein generating a notification comprises generating a notification when a change in social media profile data exceeds a threshold.

12. The computer implemented method according to claim 1, wherein providing real-time access to the notification comprises providing at least one of an email, a short message service (SMS) message, a prompt on a user interface of the SMSE platform, and a prompt on a user device associated with a user.

13. The computer implemented method according to claim 1, further comprising obtaining a request to initiate a transaction associated with the social media stock exchange platform, the transaction comprising at least one of buying and selling a stock associated with at least one social media profile data, authenticating the transaction, recording the transaction, and providing a confirmation of the executed transaction.

14. A computing system for providing users with real-time information about social media profile status in association with a social media stock exchange platform, the computing system comprising:
at least one computing processor; and
memory comprising instructions that, when executed by the at least one computing processor, enable the computing system to:
store social media profile data from a plurality of social media platform in at least one network-based storage device, the social media profile data being stored in a standardized format, the social media profile data associated with a plurality of social media content creators;
obtain updated social media profile data from a plurality of social media platforms, the updated social media profile data comprising a non-standardized format based on the social media platform from which the social media profile data was obtained;
convert the non-standardized format of the updated social media profile data into the standardized format;
storing the updated social media profile data in the standardized format;
automatically generate a notification associated with the updated social media profile data; and
provide a plurality of users of the social media stock exchange platform with real-time access to the notification over a computer network so that each user has immediate access to the up to date information in the standardized format for use in making trading decisions via the social media stock exchange platform.

15. A computer readable medium comprising instructions that when executed by a processor enable the processor to execute a computer implemented method for providing users with real-time information about social media profile status in association with a social media stock exchange platform, the computer implemented method comprising:
storing social media profile data from a plurality of social media platform in at least one network-based storage device, the social media profile data being stored in a standardized format, the social media profile data associated with a plurality of social media content creators;
obtaining updated social media profile data from a plurality of social media platforms, the updated social media profile data comprising a non-standardized format based on the social media platform from which the social media profile data was obtained;
converting the non-standardized format of the updated social media profile data into the standardized format;
storing the updated social media profile data in the standardized format;
automatically generating a notification associated with the updated social media profile data; and
providing a plurality of users of the social media stock exchange platform with real-time access to the notification over a computer network so that each user has immediate access to the up to date information in the standardized format for use in making trading decisions via the social media stock exchange platform.
